(19) United States
(12) Patent Application Publication
(10) Pub. No.: US 2025/0315478 A1
(43) Pub. Date: Oct. 9, 2025

(54) METHOD TO DECODE AND DISCOVER USING XML XPATH QUERIES

(71) Applicant: Aeronix, Inc., Melbourne, FL (US)

(72) Inventors: Ted Dubroff, Melbourne, FL (US); Patrick Hagerty, Melbourne, FL (US); Levi Mutter, Melbourne, FL (US)

(73) Assignee: Aeronix, Inc., Melbourne, FL (US)

(21) Appl. No.: 19/170,653

(22) Filed: Apr. 4, 2025

Related U.S. Application Data
(60) Provisional application No. 63/574,447, filed on Apr. 4, 2024.

(51) Int. Cl. G06F 16/835; G06F 9/54; G06F 16/84

(52) U.S. Cl. CPC G06F 16/835; G06F 9/546; G06F 16/84

(57) ABSTRACT

A method for creating a standardized XML format including the steps of (1) defining an event element, (2) creating a template file having the event element; (3) identifying a message on a shared bus; (4) determining a bus message type of the message; and (5) creating an output XML file based on the template file when the value of the bus message type is equal to the value of the event user identification attribute.

### RELATED APPLICATIONS

This application claims priority under 35 U.S.C. § 119(e) of U.S. Provisional Patent Application Ser. No. 63/574,447 (Attorney Docket No. 1949.00020) filed on Apr. 4, 2024 and titled METHOD TO DECODE AND DISCOVER USING XML XPATH QUERIES. The content of this application is incorporated herein by reference.

### FIELD OF THE INVENTION

The present invention relates to systems and methods for parsing and conversion of universal armament interface messages into a standard format.

### BACKGROUND OF THE INVENTION

In many defense industry applications, bus monitors for universal armament interface (UAI) messages may output MIL-STD-1769 data in a plurality of formats. Analysis of and implementation of graphical user interfaces (GUIs) for display of this data is difficult due to the disparate formats of the messages. Additionally, runtime querying and display of UAI messages is not possible due to the differing formats of the messages. Therefore, a need exists for a system to convert the messages output by the UAI bus monitors into a standard format.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a method for creating a standardized XML format including the steps of (1) defining an event element, (2) creating a template file having the event element; (3) identifying a message on a shared bus; (4) determining a bus message type of the message; and (5) creating an output XML file containing an element based on the template file when the value of the bus message type is equal to the value of the transmission user identification attribute.

The method may further include the steps of: (6) creating a first template file having a first event element wherein the transmission user identification attribute of the transmission element of the first template file has a first value; (7) creating a second template file having a second event element wherein the transmission user identification attribute of the transmission element of the second template file has a second value; (8) creating an output XML file containing a first element based on the first template file when the value of the bus message type is equal to the first value; and (9) creating a second element of output XML file based on the second template file when the value of the bus message type is equal to the second value.

The method may still further include the steps of: (10) creating a third template file having a third event element wherein the transmission user identification attribute of the transmission type element of the third template file has a third value; and (11) creating a third element of the output XML file based on the third template file when the value of the bus message type is equal to the third value.

The event element may be defined to include an event user identification attribute and a transmission element.

The event user identification attribute may have a value.

The transmission element may include a metadata element and a transfer element. The transmission element may include a transmission user identification attribute, a transmission type attribute, a transmission name attribute, and a transmitting type count attribute.

The transmission user identification attribute, transmission type attribute, transmission name attribute, and transmission type count attribute may each have a value.

The transfer element may include a transfer type attribute, a transfer receiver attribute, and a transfer sender attribute. The transfer type attribute, transfer receiver attribute, and transfer sender attribute may each have a value.

The transfer element may further include a from controller element.

The from controller element may include (1) a receive command element and (2) a data words element when the message is received. The from controller element may include a transmit command element when the message is transmitted.

The receive command element may include (1) a remote terminal address element, (2) a sub address or mode element, (3) a word count or mode code element, and (4) a command word element.

The transmit command element may also include (1) a remote terminal address element, (2) a sub address or mode element, (3) a word count or mode code element, and (4) a command word element.

The transfer element may include a from receiving device element when the message is received. The transfer element may include a from transmitting device element when the message is transmitted.

The from receiving device element may include a status word element.

The from transmitting device element may include a status word element and a data words element.

The transfer element may include an error element, which may be assigned a value to indicate that no error is present.

The transmission element may include a metadata element.

The metadata element may include (1) an event date time element; (2) a snooper type element; (3) a standard element; and (4) a bus element.

The event user identification attribute of the event element of the template may have a value equal to the value of the transmission user identification attribute of the template.

The value of the transfer type attribute may indicate both a transmitter of the message and a receiver of the message. The value of the transfer receiver attribute may indicate the receiver of the message. The value of the transfer sender attribute may indicate the transmitter of the message.

### BRIEF DESCRIPTION OF THE DRAWINGS

Some embodiments of the present invention are illustrated as an example and are not limited by the figures of the accompanying drawings, in which like references may indicate similar elements.

FIG. 1 is an XML output file according to an embodiment of the invention.

FIG. 2 is an XML output file according to another embodiment of the invention.

FIG. 3 is an XML output file according to yet another embodiment of the invention.

FIG. 4 is a flowchart of a method for creating a standardized XML format according to an embodiment of the invention.

FIG. 5 is a flowchart of a method for creating a standardized XML format according to an embodiment of the invention.

FIG. 6 is a flowchart of a method for creating a standardized XML format according to an embodiment of the invention.

FIG. 7 is a block diagram of an event element for a received message according to an embodiment of the invention.

FIG. 8 is a block diagram of an event element for a transmitted message according to an embodiment of the invention.

FIG. 9 is an XML template file according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

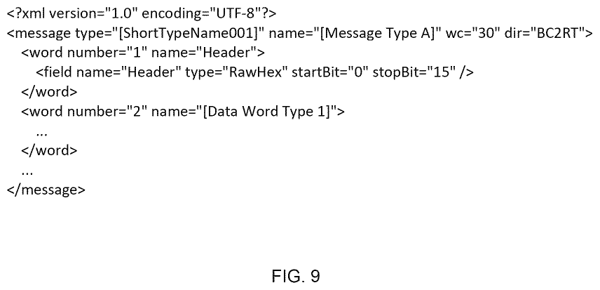

An embodiment of the invention, as shown and described by the various figures and accompanying text, provides a system and method for converting Universal Armament Interface (UAI) messages into a standardized XML format. In one embodiment, the UAI message may be raw message data output from a bus monitor. The inventive system 100 may include a plurality of XML template files. Each message type output by the UAI may be associated with an XML template file. By way of example, and not as a limitation, an XML template file is depicted by FIG. 9. The system 100 may convert the information contained in each message output by the UAI into the format of the associated XML template file. The output of the system may be an XML file containing data a plurality of event elements, each formatted from the template files with data acquired from the UAI output messages. As part of a UAI analysis application, the output XML file may be queried using XPath queries. This may be beneficial in creating or updating graphical user interface (GUI) elements.

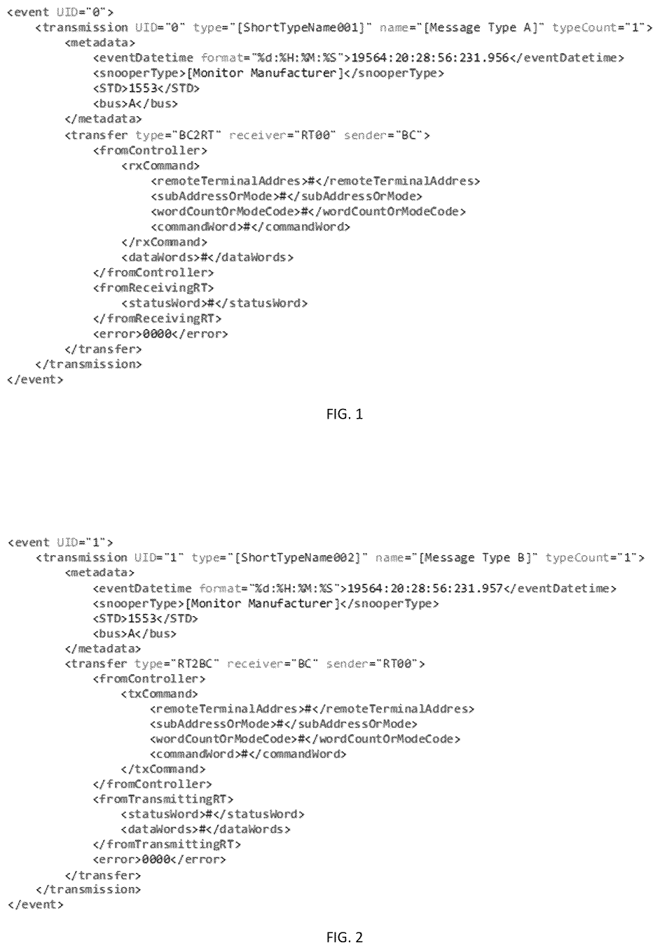

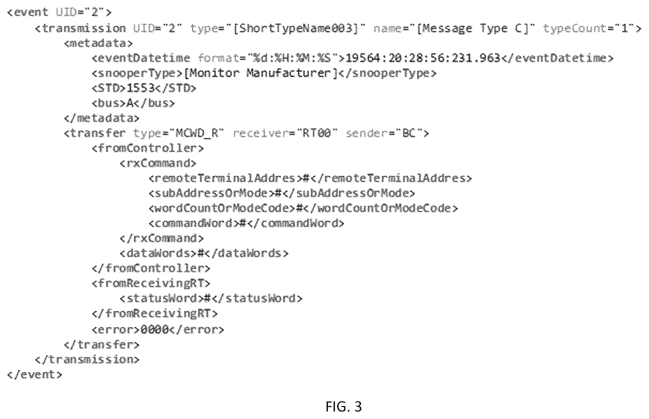

As depicted in FIG. 1, one embodiment of an XML output file may include data from a received message. As depicted in FIG. 2, another embodiment of an XML output file may include data from a transmitted message. As depicted in FIG. 3, yet another embodiment of an XML output file may include data from a received message of a different type than that depicted in FIG. 1. As depicted in FIGS. 1, 2, & 3, a ‘#’ may signify where the numerical value or list of numerical values may be inserted from data included in the UAI message. Similarly, as depicted in FIGS. 1, 2, & 3, data contained within brackets may signify text that may be inserted from data included in the UAI message.

A GUI may be implemented to receive the output XML file and display the information in a consistent manner. Similarly, a system may be created to analyze the generated XML files and provide information related to the data contained therein.

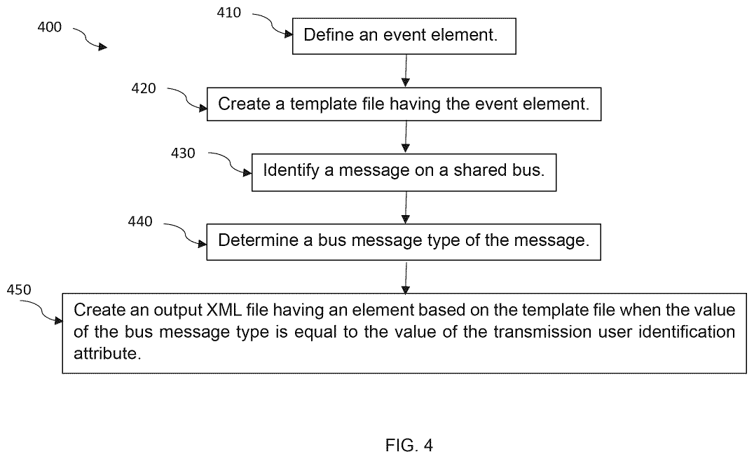

In one embodiment, as depicted at least in FIG. 4, the method for creating a standardized XML format 400 may include the steps of defining an event element (410), creating a template file containing the event element (420), identifying a message on a shared bus (430), determining a bus message type of the message (440), and creating an output XML file containing an element based on the template file when the value of the bus message type is equal to the value of the transmission user identification attribute of the template file (450).

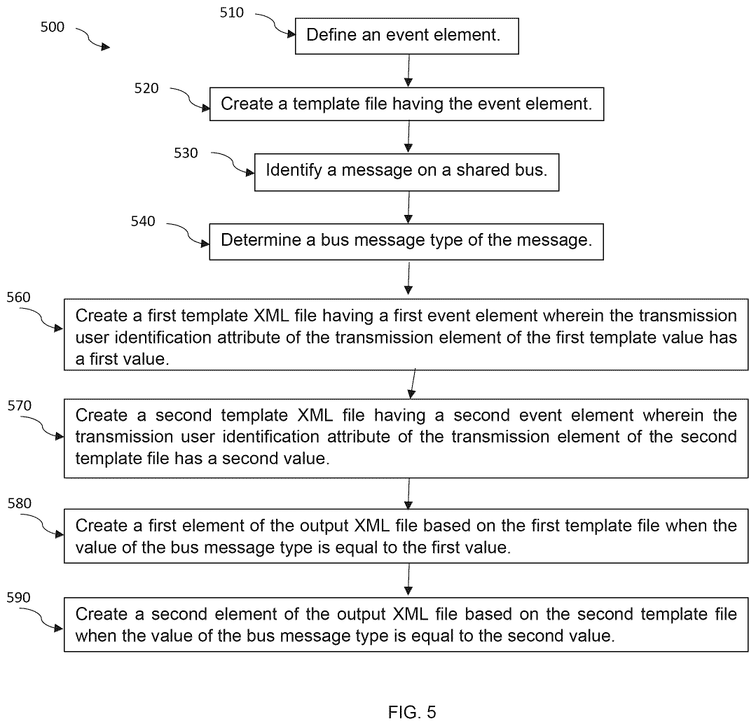

In another embodiment, as depicted at least in FIG. 5, the method for creating a standardized XML format 500 may include the steps of defining an event element (510), creating a template file containing the event element (520), identifying a message on a shared bus (530), determining a bus message type of the message (540), creating a first template XML file having a first event element wherein the transmission user identification attribute of the transmission element of the first template file has a first value (560), creating a second template XML file having the event element wherein the transmission user identification attribute of the transmission element of the second template file has a second value (570), creating a first element of the output XML file based on the first template file when the value of the bus message type is equal to the first value (580), and creating a second element of the output XML file based on the second template file when the value of the bus message type is equal to the second value (590).

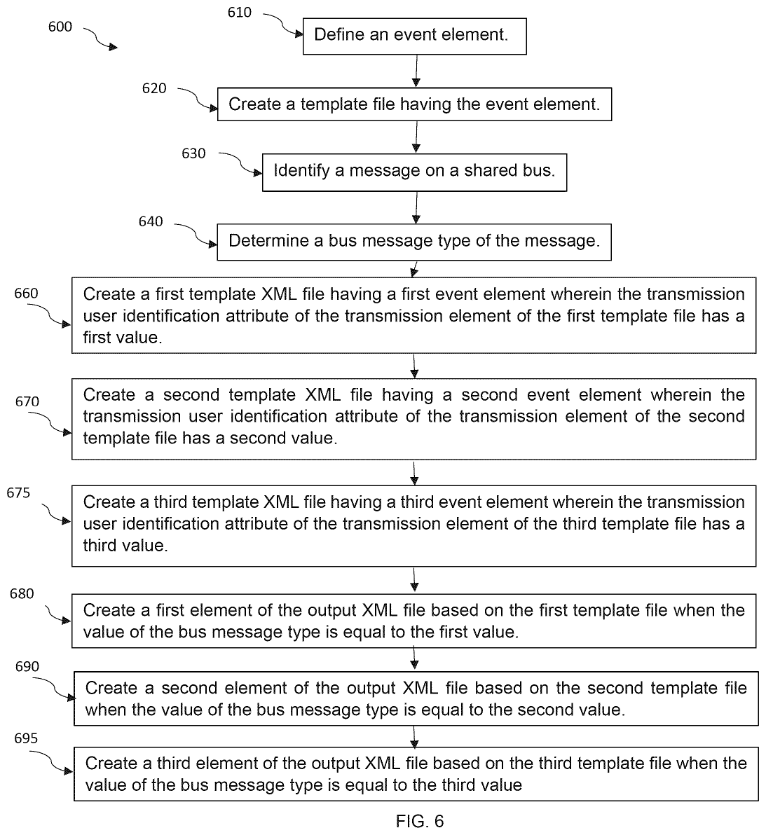

In yet another embodiment, as depicted at least in FIG. 6, the method for creating a standardized XML format 600 may include the steps of defining an event element (610), creating a template file containing the event element (620), identifying a message on a shared bus (630), determining a bus message type of the message (640), creating a first template XML file having a first event element wherein the transmission user identification attribute of the transmission element of the first template file has a first value (660), creating a second template XML file having a second event element wherein the transmission user identification attribute of the transmission element of the second template file has a second value (670), creating a third template XML file having a third event element wherein the transmission user identification attribute of the transmission element of the third template file has a third value (675), creating a first element of the output XML file based on the first template file when the value of the bus message type is equal to the first value (680), creating a second element of the output XML file based on the second template file when the value of the bus message type is equal to the second value (690), and creating a third element of the output XML file based on the third template file when the value of the bus message type is equal to the third value (695).

The bus messages may be with transmitted or received. Templates files for transmitted and received messages may have different structures for the output XML file. By way of example, and not as a limitation, the output XML file may be written as depicted in any of FIGS. 1-3.

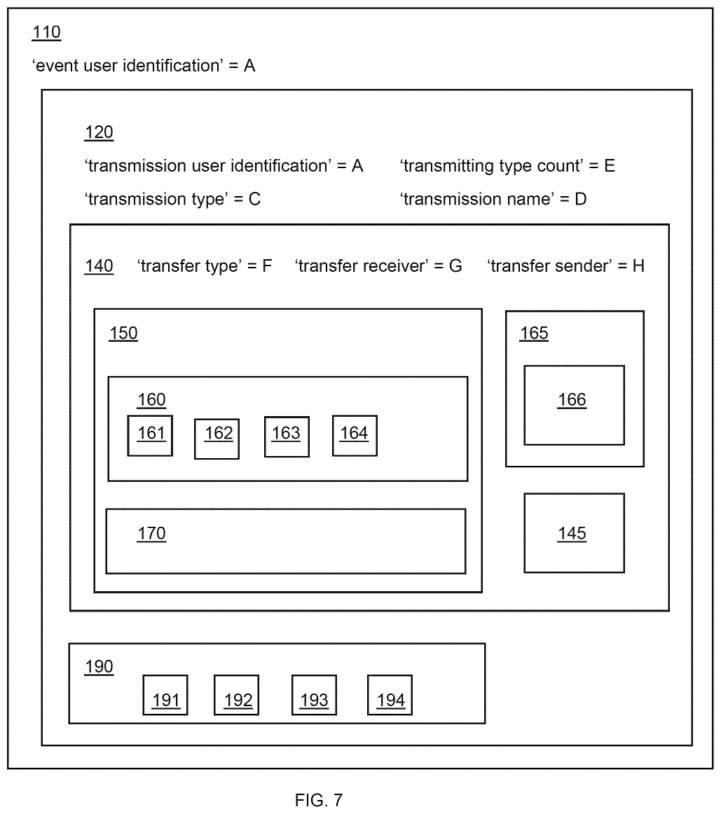

In one embodiment, as depicted in FIG. 7, the event element 110 for a received message may include a transmission element 120 and an event user identification attribute. The transmission element 120 may include one or more of a transfer element 140, a metadata element 190, a transmission user identification attribute, a transmission type attribute, a transmitting type count attribute, and a transmission name attribute.

The metadata element 190 may include an event date time element 191, snooper type element 192, standard element 193, and bus element 194.

The transfer element 140 may further include one or more of a from controller element 150, a from receiving device element 165, and an error element 145.

The from receiving device element 165 may include a status word element 166.

The from controller element 150 may include a receive command element 160 and a data words element 170.

The receive command element 160 may include a remote terminal address element 161, sub address or mode element 162, word count or mode code element 163, and command word element 164.

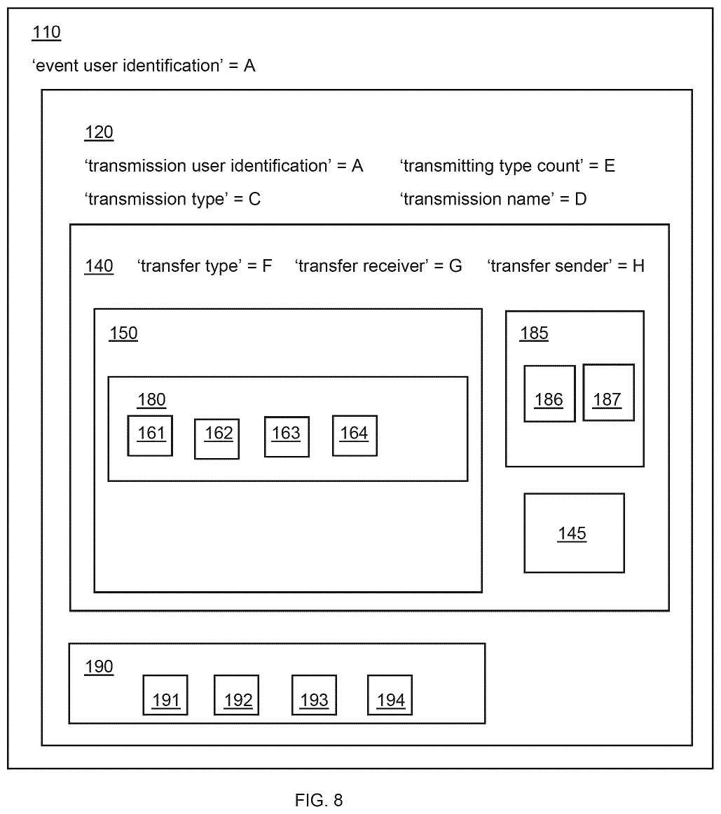

The event element 110 for a transmitted message is depicted in FIG. 8. Similar to the event element 110 for a received message, the event element 110 for a transmitted message may include a transmission element 120 and an event user identification attribute. The transmission element 120 may include one or more of a transfer element 140, a metadata element 190, a transmission user identification attribute, a transmission type attribute, a transmitting type count attribute, and a transmission name attribute.

The metadata element 190 may include an event date time element 191, snooper type element 192, standard element 193, and bus element 194.

The transfer element 140 for the transmitted element may further include one or more of a from controller element 150, a from transmitting device element 185, and an error element 145.

The from transmitting device element 185 may include a status word element 186 and a data words element 187.

The from controller element 150 for a transmitted message may include a transmit command element 180. Similar to the receive command element 160 for a received message, the transmit command element 80 may include a remote terminal address element 161, sub address or mode element 162, word count or mode code element 163, and command word element 164.

Those having skill in the art will appreciate that the elements and attributes are named to convey information about what data is labeled with each element or attribute.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A method for creating a standardized XML format comprising the steps of:
defining an event element wherein the event element comprises:
an event user identification attribute having a value;
a transmission element, wherein the transmission element further comprises:
a transmission user identification attribute having a value,
a transmission type attribute having a value,
a transmission name attribute having a value,
a transmission type count attribute having a value, and
a transfer element, wherein the transfer element further comprises:
a transfer type attribute having a value,
a transfer receiver attribute having a value, and
a transfer sender attribute having a value;
creating a template file having the event element;
identifying a message on a shared bus;
determining a bus message type of the message; and
creating an output XML file containing a first element based on the template file when the value of the bus message type is equal to the value of the transmission user identification attribute.

2. The method according to claim 1 further comprising the steps of:
creating a first template file having a first event element wherein the transmission user identification attribute of the first transmission element of the first template file has a first value;
creating a second template file having a second event element wherein the transmission user identification attribute of the second transmission element of the second template file has a second value;
creating a first element of the output XML file based on the first template file when the value of the bus message type is equal to the first value; and
creating a second element of the output XML file based on the second template file when the value of the bus message type is equal to the second value.

3. The method according to claim 2 further comprising the steps of:
creating a third template file having a third event element wherein the transmission user identification attribute of the third transmission element of the third template file has a third value; and
creating a third element of the output XML file based on the third template file when the value of the bus message type is equal to the third value.

4. The method according to claim 1 wherein the transmission user identification attribute of the transmission element of the template has a value equal to the value of the event user identification attribute of the template.

5. The method according to claim 1 wherein the value of the transfer type attribute indicates both a transmitter of the message and a receiver of the message, the value of the transfer receiver attribute indicates the receiver of the message, and the value of the transfer sender attribute indicates the transmitter of the message.

6. The method according to claim 1 wherein the transfer element further comprises a from controller element.

7. The method according to claim 6 wherein the from controller element comprises a receive command element and a data words element when the message is received and a transmit command element when the message is transmitted.

8. The method according to claim 7 wherein
the transmit command element comprises:
a remote terminal address element,
a sub address or mode element,
a word count or mode code element, and
a command word element; and
the receive command element comprises:
a remote terminal address element,
a sub address or mode element,
a word count or mode code element, and
a command word element.

9. The method according to claim 1 wherein the transfer element comprises a from receiving device element when the message is received and a from transmitting device element when the message is transmitted.

10. The method according to claim 9 wherein
the from receiving device element comprises:
a status word element; and
the from transmitting device element comprises:
a status word element, and
a data words element.

11. The method according to claim 1 wherein the transfer element comprises an error element.

12. The method according to claim 11 wherein the error element is assigned a value to indicate that no error is present.

13. The method according to claim 1 wherein the transmission element comprises a metadata element.

14. The method according to claim 13 wherein the metadata element comprises:
an event date time element;
a snooper type element;
a standard element; and
a bus element.

15. A method for creating a standardized XML format comprising the steps of:
defining an event element wherein the event element comprises:
an event user identification attribute having a value;
a transmission element, wherein the transmission element further comprises:
a transmission user identification attribute having a value,
a transmission type attribute having a value,
a transmission name attribute having a value,
a transmission type count attribute having a value, and
a transfer element, wherein the transfer element further comprises:
a transfer type attribute having a value,
a transfer receiver attribute having a value, and
a transfer sender attribute having a value;
creating a first template file having a first event element wherein the transmission user identification attribute of the transmission element of the first template file has a first value;
creating a second template file having a second event element wherein the transmission user identification attribute of the transmission element of the second template file has a second value;
identifying a message on a shared bus;
determining a bus message type of the message;
creating a first element of an output XML file based on the first template file when the value of the bus message type is equal to the first value; and
creating a second element of the output XML file based on the second template file when the value of the bus message type is equal to the second value.

16. The method according to claim 15 further comprising the steps of:
creating a third template file having a third event element wherein the transmission user identification attribute of the transmission type element of the third template file has a third value; and
creating a third element of the output XML file based on the third template file when the value of the bus message type is equal to the third value.

17. The method according to claim 15 wherein the transfer element further comprises a from controller element, wherein the from controller element further comprises a receive command element and a data words element when the message is received and a transmit command element when the message is transmitted.

18. The method according to claim 17 wherein
the transmit command element comprises:
a remote terminal address element,
a sub address or mode element,
a word count or mode code element, and
a command word element; and
the receive command element comprises:
a remote terminal address element,
a sub address or mode element,
a word count or mode code element, and
a command word element.

19. The method according to claim 15 wherein the transfer element comprises a from receiving device element when the message is received and a from transmitting device element when the message is transmitted; wherein the from receiving device element comprises a status word element; and the from transmitting device element comprises a status word element and a data words element.

20. A method for creating a standardized XML format comprising the steps of:
defining an event element wherein the event element comprises:
an event user identification attribute having a value;
a transmission element, wherein the transmission element further comprises:
a transmission user identification attribute having a value,
a transmission type attribute having a value,
a transmission name attribute having a value,
a transmission type count attribute having a value, and
a transfer element, wherein the transfer element further comprises:
a transfer type attribute having a value indicating both a transmitter of the message and a receiver of the message,
a transfer receiver attribute having a value indicating the receiver of the message,
a transfer sender attribute having a value indicating the transmitter of the message,
a from controller element further comprising: a receive command element and a data words element when the message is received, wherein the receive command element further comprises: a remote terminal address element, a sub address or mode element, a word count or mode code element, and a command word element; and a transmit command element when the message is transmitted, wherein the transmit command element further comprises: a remote terminal address element, a sub address or mode element, a word count or mode code element, and a command word element; and
a from receiving device element when the message is received, wherein the from receiving device element further comprises a status word element;
a from transmitting device element when the message is transmitted, wherein the from transmitting device element further comprises: a status word element, and a data words element;
an error element assigned a value to indicate that no error is present; and
a metadata element further comprising: an event date time element, a snooper type element, a standard element, and a bus element;
identifying a message on a shared bus;
determining a bus message type of the message;
creating a first template file having a first event element wherein the transmission user identification attribute of the transmission element of the first template file has a first value;
creating a second template file having a second event element wherein the transmission user identification attribute of the transmission element of the second template file has a second value;
creating a third template file having a third event element wherein the transmission user identification attribute of the transmission element of the third template file has a third value;
creating a first element of an output XML file based on the first template file when the value of the bus message type is equal to the first value; and
creating a second element of the output XML file based on the second template file when the value of the bus message type is equal to the second value; and
creating a third element of the output XML file based on the third template file when the value of the bus message type is equal to the third value.
